(19) United States
(12) Patent Application Publication
(10) Pub. No.: US 2023/0150053 A1
(43) Pub. Date: May 18, 2023

(54) FRICTION STIR WELDING METHOD AND FRICTION STIR WELDING APPARATUS

(71) Applicant: HONDA MOTOR CO., LTD., Tokyo (JP)

(72) Inventors: Toshihide SUNADA, Tokyo (JP); Satoshi MATSUURA, Tokyo (JP); Yoshihiro KIKIMA, Tokyo (JP); Atsuhiro HATANAKA, Tokyo (JP)

(21) Appl. No.: 18/049,640

(22) Filed: Oct. 26, 2022

(30) Foreign Application Priority Data
Nov. 16, 2021 (JP) 2021-186224

(51) Int. Cl. B23K 20/12; B23K 37/04

(52) U.S. Cl. CPC B23K 20/1225; B23K 20/126; B23K 37/0435

(57) ABSTRACT

The present invention makes it possible to weld workpieces to each other efficiently firmly by friction stir welding while reducing labor and man-hours. A friction stir welding method includes a fixing step, a temporary welding step S2, and a main welding step as follows. The fixing step includes fixing the workpieces W1 and W2 to a receiving table by pressing the workpieces W1 and W2 against the receiving table by means of a plurality of spring pins 10 that, are spaced apart from one another. The temporary welding step S2 includes spot-welding the workpieces W1 and W2 to each other by friction stir welding at locations different from positions of the spring pine 10. The main welding step includes line-welding the spot-welded workpieces W1 and W2 to each other by friction stir welding.

This application is based on and claims the benefit of priority from Japanese Patent Application No. 2021-186224, filed on 16 Nov. 2021, the content of which is incorporated herein by reference.

### BACKGROUND OF THE INVENTION

### Field of the Invention

The present invention relates to a method and apparatus for welding workpieces of aluminum materials or the like to each other by friction stir welding.

### Related Art

When friction stir welding workpieces to each other, from a viewpoint of welding strength or the like, it is desirable to eliminate a gap between the workpieces as much as possible and to weld the workpieces to each other in a state in which the workpieces have been brough into close contact with each other as much as possible. Therefore, for example, the workpieces may be flattened by machining before welding, may have surfaces pressed with a pneumatically or hydraulically driven jig before welding, or may be temporarily welded to each other by spot-welding before main welding.

Patent Document 1: Japanese Unexamined Patent Application, Publication No. 2007-038253

### SUMMARY OF THE INVENTION

However, flattening workpieces before welding results in an increase in labor and man-hours required prior to friction stir welding.

In a case of temporarily welding workpieces by spot-welding in a state where the workpieces are being pressed by means of a surface (hereinafter referred to as “surface-pressed”, “surface-pressing”, etc.), it is necessary to temporarily weld the workpieces outside a surface-pressing member, for avoiding interference with the surface-pressing member that, spreads in a planar, shape. Therefore, a certain region cannot be temporarily welded, which may cause a region to remain without being temporarily welded with a sufficient density. Furthermore, temporary welding can be performed only outside the surface-pressing member, and hence there is concern that temporary welding can be performed only at a position where workpieces are not sufficiently in close contact with each other. As described above, there is concern that a coupling force in temporary welding becomes insufficient and that a temporarily welded workpiece is separated to be turned up due to stirring in a main welding step (friction stir welding). The disadvantages described above are noticeable especially in a case where workpieces are large because a large surface-pressing member is used accordingly.

The present invention has been achieved in view of the circumstances described above and it is an object of the present invention to friction stir weld workpieces to each other efficiently firmly while reducing labor and man-hours.

The present inventors have made the present invention based on the findings that firm temporary welding of workpieces can be efficiently achieved by a procedure in which the workpieces are pressed against a receiving table by means of a plurality of spring pins spaced apart from each other, and the workpiece are temporarily welded to each other in a state of being pressed, at locations different from the positions of the spring pins. The present invention provides a friction stir welding method according to the following aspects features (1) to (4), and a friction stir welding apparatus according to the following aspect (5).

(1) A friction stir welding method for friction stir welding workpieces to each other, the method including:

a fixing step of fixing the workpieces to a receiving table by pressing the workpieces against the receiving table by means of a plurality of spring pins that are spaced apart from one another;
a temporary welding step of spot-welding the workpieces to each other by friction stir welding the workpieces at locations different from positions of the spring pins in a state where the workpieces are fixed; and
a main welding step of line-welding the spot-welded workpieces to each other by friction stir welding.

According to the aspect (1) above, while the workpieces are pressed by means of the plurality of spring pins, the workpieces are temporarily welded to each other (spot-welded) at the locations different from the positions of the spring pins. Therefore, a certain region that cannot be temporarily welded is smaller, in comparison with a case of temporarily welding the workpieces to each other outside a surface-pressing part to avoid interference with the surface-pressing part, while pressing the workpieces with the surface-pressing part that spreads in a planar shape. This feature makes it easy to temporarily weld respective portions of the workpieces with a sufficient density. Furthermore, in comparison with a case where temporary welding can be performed only outside the surface-pressing part that spreads in a planar shape, the workpieces can be easily temporarily welded at an appropriate position where the workpieces are sufficiently in full contact with each other. As a result, firm temporary welding can be efficiently achieved, and even by way of temporary welding at a level similar to spot-welding, the workpieces can be inhibited from being turned up due to friction stirring in the main welding step. As a result, the workpieces can be friction stir welded to each other efficiently firmly.

Further, according to the aspect (1), prior to the main welding step, the workpieces only need to be pressed against the receiving table by means of the plurality of spring pins and temporarily welded (spot-welded), and hence labor and man-hours required prior to the main welding step are reduced, for example, in comparison with a case where the workpieces are flattened by machining.

As described above, according to aspect (1), the workpieces can be friction stir welded to each other efficiently firmly, while reducing the labor and man-hours.

(2) In the friction stir welding method according to aspect (1), the temporary welding step includes performing the spot-welding at a corner of an outer edge of a first workpiece as one of the workpieces, and the main welding step includes performing the line-welding along the outer edge.

According to aspect (2) above, temporary welding (spot-welding) is performed in a corner portion that is likely to be turned up in a case of performing the friction stir welding (line-welding) along the outer edge of the workpiece. Therefore, also in this respect, the workpiece can be efficiently inhibited from being turned up. Further, the corner is hard to press by means of the spring pin and is not very suitable for placing the spring pin, and hence the corner portion can be effectively used in performing the temporary welding.

(3) In the friction stir welding method according to aspect (1) or (2), the workpieces include a first workpiece made of an expanded material and a second workpiece made of a die-cast material, and the fixing step includes pressing the first workpiece against the second workpiece by means of the plurality of spring pins. Examples of the expanded material include a press material, an extruded material and the like processed by rolling or forging during manufacturing.

According to aspect (3) above, the first workpiece of the expanded material in which flatness is easy to obtain is pressed against the second workpiece of the die-cast material in which flatness is hard to obtain. Therefore, the second workpiece in which flatness is hard to obtain is held between the first workpiece in which flatness is easy to obtain and the receiving table or the like and is easily corrected to be flattened. Specifically, also in the present invention in which a plurality of locations of the workpieces are discretely pressed by means of the plurality of spring pins, the second workpiece in which flatness is hard to obtain can be surface-pressed by the first workpiece in which flatness is easy to obtain. Therefore, also in this respect, temporary welding can be efficiently firmly performed.

(4) In the friction stir welding method according to any one of aspects (1) to (3), the workpieces include a first workpiece and a second workpiece,

the second workpiece has an opening that opens in a predetermined direction, and a stepped portion that is recessed in a direction opposite to the predetermined direction and is provided outside an inner peripheral surface of the opening, the stepped portion having a bottom surface continuous with an inner peripheral surface of the opening, the fixing step includes fitting an outer edge portion of the first workpiece into the stepped portion of the second workpiece, and pressing the first workpiece against the second workpiece in the direction opposite to the predetermined direction by means of the plurality of spring pins,
the temporary welding step includes spot-welding the first workpiece and the second workpiece in a butted portion including a side surface of the outer edge portion of the first workpiece and a portion of the second workpiece that faces the side surface, and
the main welding step includes line-welding the first workpiece to the second workpiece in an overlap portion in which the bottom surface of the stepped portion and the first workpiece overlap with each other in the predetermined direction.

According to aspect (4) above, the first workpiece can be positioned with respect to the second workpiece by fitting the outer, edge portion of the first workpiece into the stepped portion of the second workpiece, and also in this respect, the temporary welding can be more efficiently performed. Further, the main welding step includes performing the line-welding in the overlap portion, and hence welding strength can be more easily obtained in comparison with a case of performing the line-welding in the butted portion.

(5) A friction stir welding apparatus for friction stir welding workpieces to each other, the apparatus comprising: a plate including spring pins mounted at a plurality of locations that are spaced apart from one another, and having insertion holes in a plurality of locations that are different from and do not interfere with the plurality of locations, the plate being configured to fix the workpieces to a receiving table by pressing the workpieces against the receiving table by means of the plurality of spring pins;

a temporary welding tool that spot-welds the workpieces to each other by friction stir welding in the insertion holes; and
a main welding tool that line-welds the spot-welded workpieces to each other by friction stir welding.

According to aspect (5) above, effects similar to those of the method of aspect (1) can be obtained.

As described above, according to present invention, workpieces can be friction stir welded to each other efficiently firmly, while reducing labor and man-hours.

### BRIEF DESCRIPTION OF THE DRAWINGS

FIG. 1 is a front cross-sectional view showing a friction stir welding apparatus of a first embodiment;

FIG. 2 is a front cross-sectional view showing a first half of a fixing step;

FIG. 3 is a front cross-sectional view showing a second half of the fixing step;

FIG. 4 is a plan view showing completion of the fixing step;

FIG. 5 is a front cross-sectional view showing a fixing step of a modification;

FIG. 6 is a front cross-sectional view showing the fixing step of the present embodiment;

FIG. 7 is a front cross-sectional view showing a temporary welding step;

FIG. 8 is a plan view showing completion of the temporary welding step;

FIG. 9 is a front cross-sectional view showing a main welding step;

FIG. 10 is a plan view showing the main welding step;

FIG. 11 is a perspective view showing a modification;

FIG. 12 is a front cross-sectional view showing a fixing step of a second embodiment; and

FIG. 13 is a front cross-sectional view showing a main welding step.

### DETAILED DESCRIPTION OF THE INVENTION

Hereinafter, embodiments of the present invention will be described with reference to the drawings. However, the present invention is not limited to the following embodiments and can be appropriately modified and implemented within a range that does not depart from the spirit of the present invention.

### First Embodiment

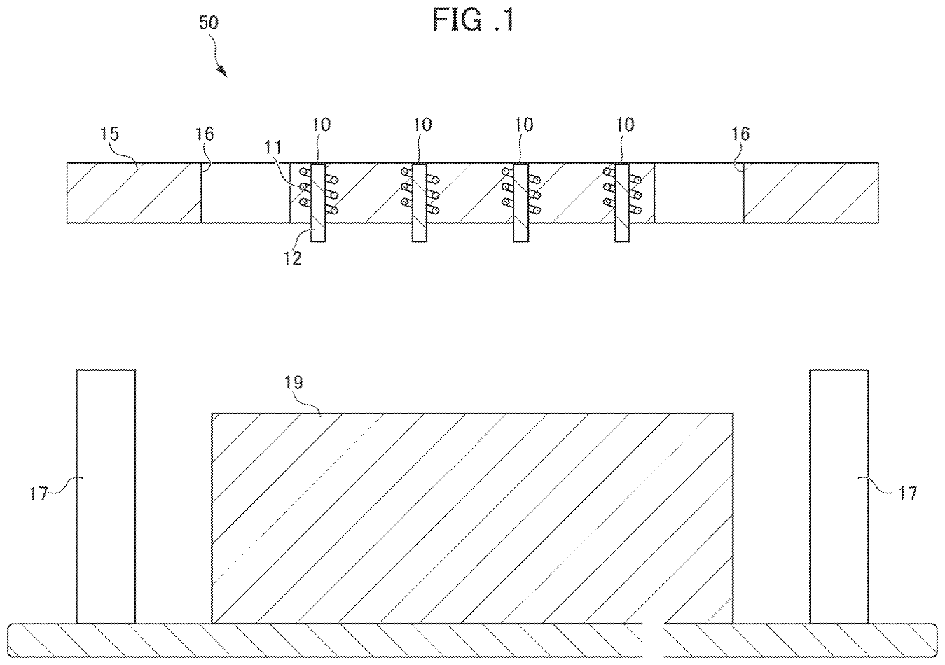

FIG. 1 is a front cross-sectional view showing a friction stir welding apparatus 50 of the present embodiment. The friction stir welding apparatus 50 includes a receiving table 19, a plate 15, a support stand 17, and a plurality of spring pins 10.

The receiving table 19 is a table on which a first workpiece W1 and a second workpiece W2 that are to be friction stir welded to each other are placed with a surface length direction of the workpieces being parallel to a horizontal direction. The plate 15 is mounted on the support stand 17 and is thereby disposed above the receiving table 19 such that the surface length direction of the plate 15 is parallel to the horizontal direction.

The spring pins 10 are mounted to the plate 15 at a plurality of locations that are spaced apart from one another in the horizontal direction. Specifically, each spring pin 10 includes a pin 12 and a spring 11. Each pin 12 is supported by the plate 15 such that the pin 12 can be displaced in an up-down direction. The spring 11 is provided around the pin 12, supported by the plate 15, and urges the pin 12 downward (toward that receiving table 19). The plate 15 downwardly presses, by means of the plurality of spring pins 10, the workpieces W1 and W2 at a plurality of locations spaced apart from one another in the horizontal direction, thereby fixing the workpieces W1 and W2 to the receiving table 19 while pressing the workpieces W1 and W2 against the receiving table 19.

The plate 15 has insertion holes 16 at a plurality of locations that do not interfere with the spring pins 10 (i.e., locations that do not overlap with the spring pins 10 in a planar view). Each insertion hole 16 is a hole through which a temporary welding tool 20 for temporarily welding the workpieces W1 and W2 to each other is inserted from above in a downward direction.

A friction stir welding method of the present embodiment includes a fixing step S1, a temporary welding step S2 and a main welding step S3, which are described below.

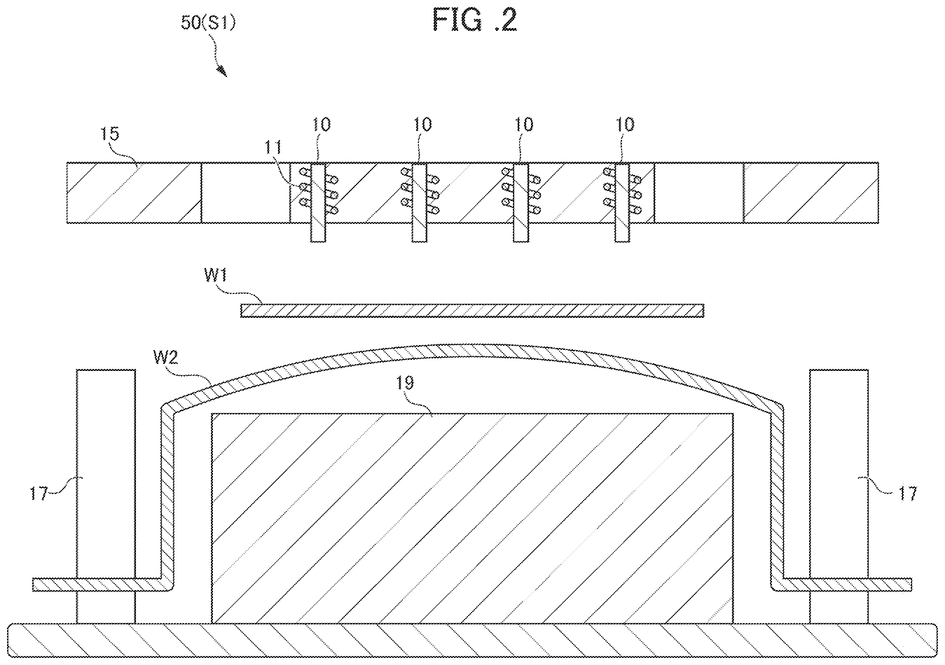

FIG. 2 is a front cross-sectional view showing a first half of the fixing step S1. In the first half of the fixing step S1, a worker or the like sets the second workpiece W2 on the receiving table 19 and sets the first workpiece W1 on the second workpiece W2. The first workpiece W1 is made of an expanded material, and the second workpiece W2 is made of a die-cast material. Therefore, it is easier to obtain flatness in the first workpiece W1 than in the second workpiece W2. This is because in the die-cast material, curves such as warpage and undulation and a change in plate thickness (nonuniformity) are likely to be generated by contraction of the material due to heat lowering after molding, whereas the expanded material (press material, extruded material) is flatly stretched and molded and is therefore easy to ensure flatness.

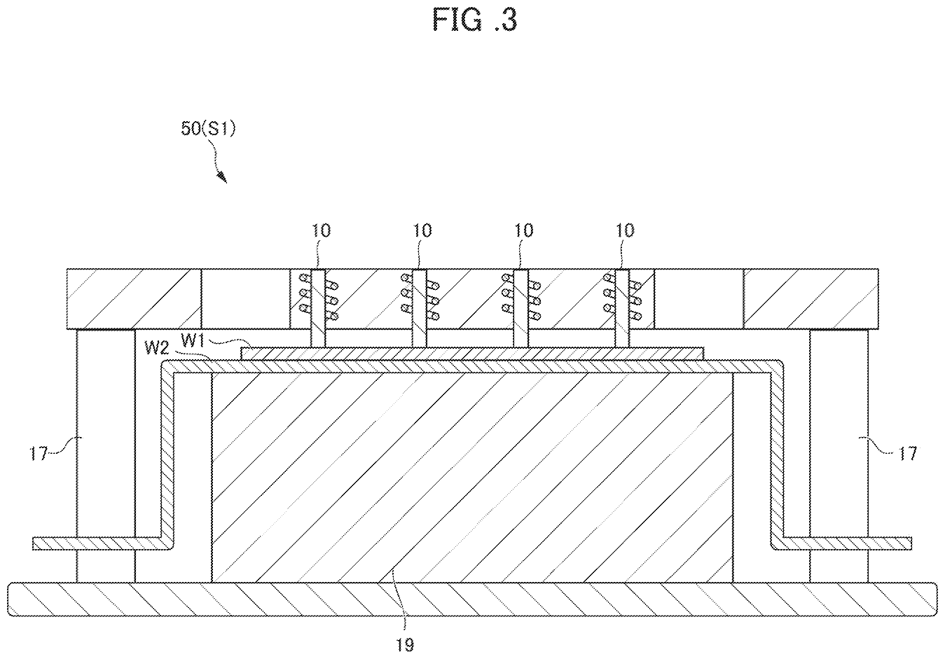

FIG. 3 is a front cross-sectional view showing a second half of the fixing step S1. In the second half of the fixing step S1, the worker or the like mounts the plate 15 on the support stand 17, thereby placing the plate 15 above the workpieces W1 and W2. As a result, the first workpiece W1 and the second workpiece W2 are fixed to the receiving table 19 while being pressed against the receiving table 15 by means of the plurality of spring pins 10 distributed and arranged in the plate 15.

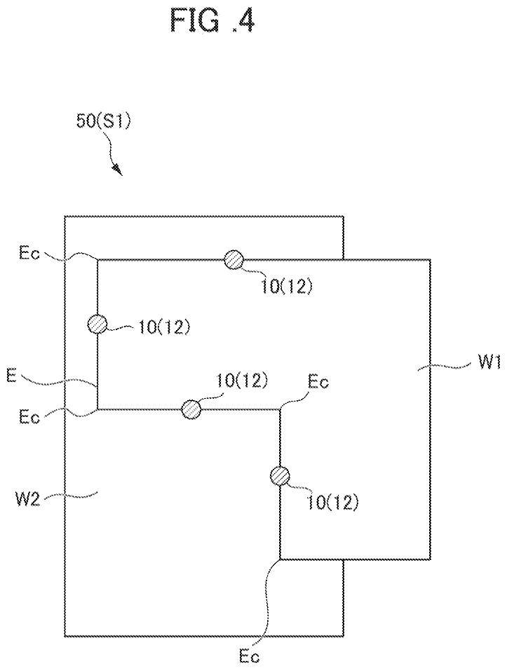

FIG. 4 is a plan view showing an example at completion of the fixing step S1. For example, as shown in FIG. 4, the plurality of spring pins 10 are disposed in portions other than corners Ec of an outer edge E of the first workpiece W1. However, in place of or in addition to these portions, the spring pin 10 may be disposed in a portion other than the outer edge E in the first workpiece W1. The number of spring pins 10 may be arbitrarily set, for example, to five or more, 10 or more, 20 or more, or the like in accordance with a shape, size or the like of the workpieces W1 and W2.

If there is a gap between the first workpiece W1 and the second workpiece W2 due to warpages or undulations of the respective workpieces W1 and W2, welding quality deteriorates. If there is a gap between the second workpiece W2 and the receiving table 19, in the portion with the gap, the workpieces W1 and W2 cannot be pressed against the receiving table 19, which is also a factor of the deterioration of the welding quality. In this respect, according to the present embodiment, the first workpiece W1 (expanded material) in which flatness is easy to obtain is pressed against the second workpiece W2 (die-cast material) in which flatness is hard to obtain. Therefore, the first workpiece W1 can be efficiently fitted along the second workpiece W2, and the second workpiece W2 can be efficiently fitted along the receiving table 19. Hereinafter, the details will be described.

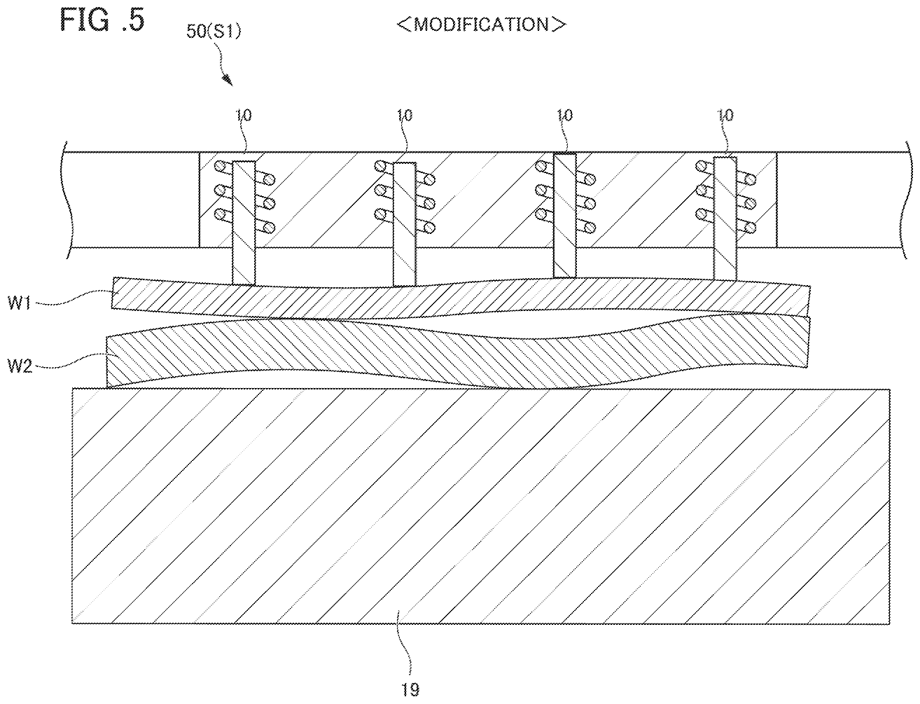

FIG. 5 shows a modification in which not only the second workpiece W2 but also the first workpiece W1 are made of a die-cast material. In FIG. 5, a curve or the like of each workpiece W1, W2 is exaggerated for visibility. Thus, according to the modification, in not only the second workpiece W2 but also the first workpiece W1, a curve such as warpage or undulation and a change in plate thickness (nonuniformity) are likely to be generated. Therefore, depending on the portion, for example, the gap between the workpieces W1 and W2 becomes large due to overlap of a curve or the like of the first workpiece W1 with a curve or the like of the second workpiece W2 in a direction reverse to a direction of the curve or the like of the first workpiece. For such a reason, for example, the first workpiece W1 cannot, be efficiently fitted along the second workpiece W2.

In a case where the workpieces W1 and W2 are strongly pressed by means of the spring pins 10 until the curves on the first workpiece W1 and the second workpiece W2 are eliminated, an output load required for the spring pins 10 and a withstand load required for the receiving table 10 increase.

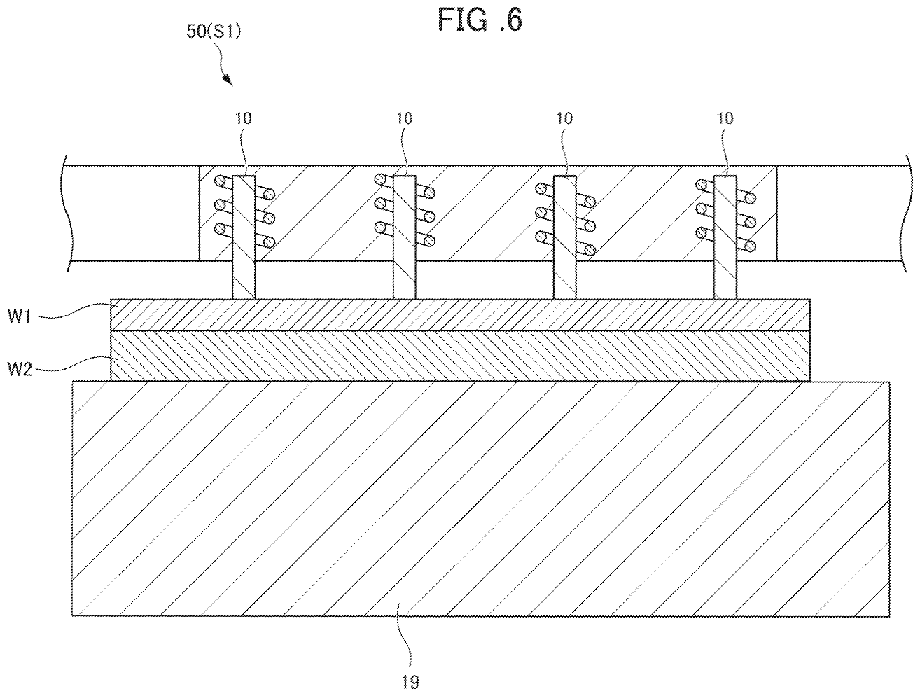

In this respect, according to the present embodiment, as shown in FIG. 6, the first workpiece W1 (expanded material) in which flatness is easy to obtain is pressed against the second workpiece W2 (die-cast material) in which flatness is hard to obtain by means of the plurality of spring pins 10. Therefore, the second workpiece W2 in which flatness is hard to obtain is held between the first workpiece W1 in which flatness is easy to obtain and the receiving table 19 and is easily corrected and flattened. Specifically, also in the present embodiment in which a plurality of locations on the workpieces W1 and W2 are discretely pressed by means of the plurality of spring pins 10, the second workpiece W2 in which flatness is hard to obtain can be surface-pressed by the first workpiece W1 in which flatness is easy to obtain. Therefore, the first workpiece W1 can be efficiently fitted along the second workpiece W2, and the second workpiece W2 can be efficiently fitted along the receiving table 19.

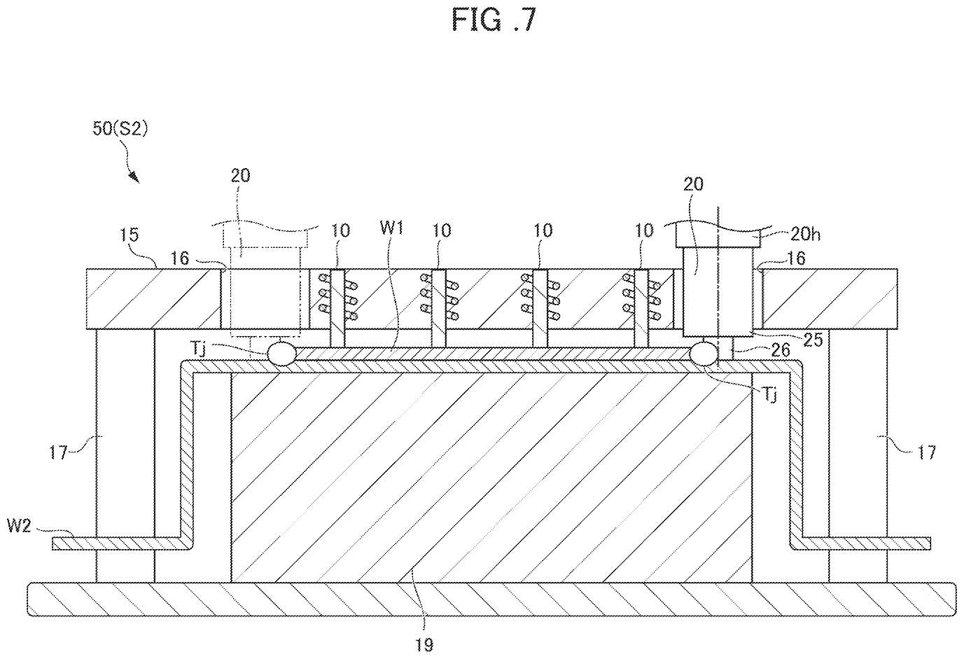

FIG. 7 is a front cross-sectional view showing the temporary welding step S2. The friction stir welding apparatus 50 further includes a movable body such as an arm, and the temporary welding tool 20. The temporary welding tool 20 protrudes downward from a head 20h of the movable body and is rotated and driven around an axis (around a vertical line) by a driver such as a motor. The temporary welding tool 20 includes a shoulder 25 that protrudes downward from a lower end of the head 20h, and a probe 26 that protrudes downward from a lower end of the shoulder 25. The friction stir welding apparatus 50 is capable of moving the temporary welding tool 20 in the vertical and horizontal directions by controlling the movable body (arm or the like).

In the temporary welding step S2, the movable body moves the temporary welding tool 20 to a position directly above the insertion hole 16, and then, lovers the temporary welding tool 20 therefrom. Thereby, the temporary welding tool 20 is inserted into the insertion hole 16, and the probe 26 is pressed against the first workpiece W1 and the second workpiece W2. Thereby, the first workpiece W1 is spot-welded to the second workpiece W2, to provide a temporarily welded portion Tj.

The spot-welding (temporary welding) may be performed sequentially by inserting one temporary welding tool 20 into a plurality of insertion holes 16 sequentially. Alternatively, in a case where the friction stir welding apparatus 50 includes a plurality of temporary welding tools 20, a plurality of locations may be simultaneously temporarily welded with the plurality of temporary welding tools 20.

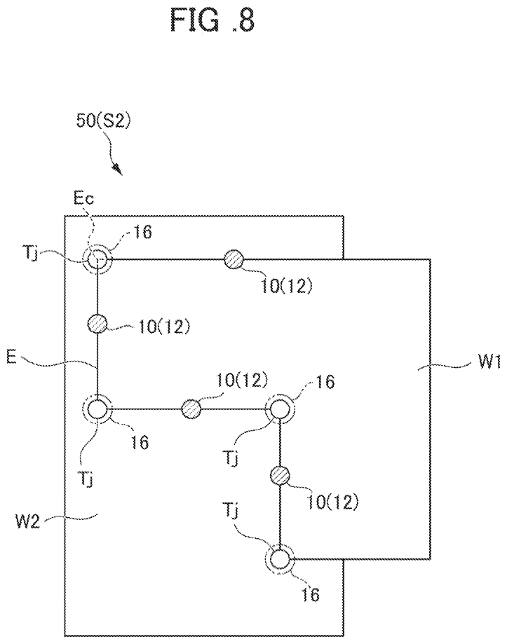

FIG. 8 is a plan view showing an example at completion of the temporary welding step S2. Each insertion hole 16 is provided at positions that overlaps with the corners Ec of the outer edge E of the first workpiece W1 in the plate 15. Therefore, in the temporary welding step S2, the corners Ec of the outer edge E of the first workpiece W1 are spot-welded to the second workpiece W2. Thereby, the temporarily welded portions Tj are provided at the corner Ec.

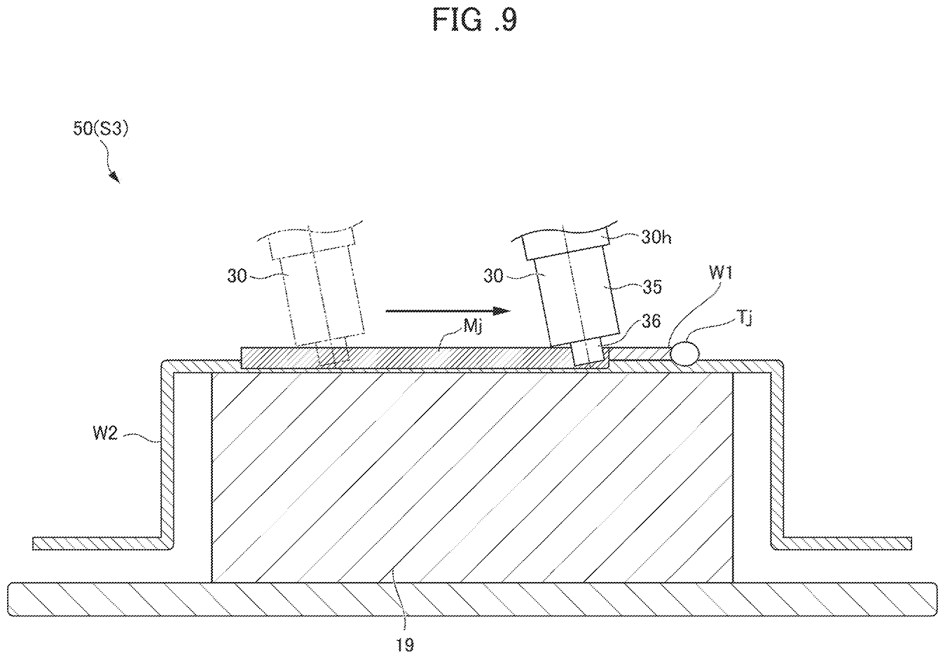

FIG. 9 is a front cross-sectional view showing the main welding step S3. The friction stir welding apparatus 50 further includes a main welding tool 30. The main welding tool 30 may be the same tool as the temporary welding tool 20 or may be another tool. FIG. 9 shows the main welding tool 30 that is different from the temporary welding tool 20, and a probe 36 that is longer than the probe 26 of the temporary welding tool 20. The main welding tool 30 also protrudes downward from a head 30h of a movable body in the same manner as the temporary welding tool 20 and is rotated and driven around an axis (around a vertical line) by a driver such as a motor. The friction stir welding apparatus 50 is capable of moving the main welding tool 30 in the vertical and horizontal directions by controlling the movable body.

In the main welding step S3, the worker or the like removes the plate 15 from the support stand 17, thereby releasing the workpieces W1 and W2 from pressing by the plurality of spring pins 10. Thereafter, the friction stir welding apparatus 50 line-welds the spot-welded workpieces W1 and W2 to each other by the friction stir welding using the main welding tool 30. Specifically, the friction stir welding apparatus 50 moves the main welding tool 30 to a position directly above a desired location inside the outer edge E of the first workpiece W1, and then, lowers main welding tool 30 therefrom. Thereby, the probe 36 is pressed onto an upper surface of the first workpiece W1 and is made to penetrate the first workpiece W1 to reach the second workpiece W2.

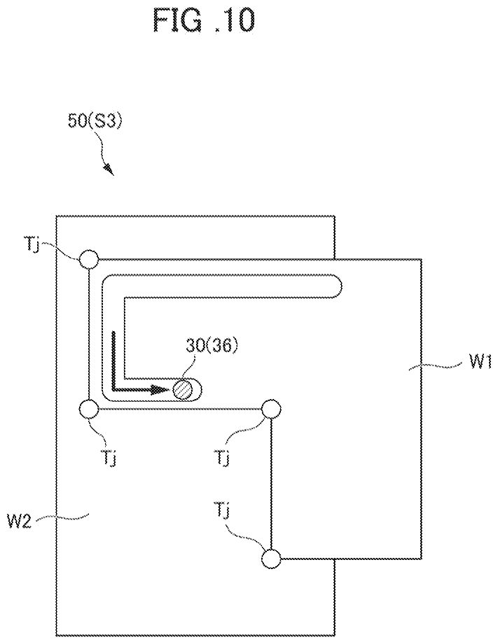

FIG. 10 is a plan view showing the main welding step S3. The friction stir welding apparatus 50 moves the main welding tool 30 along the outer edge E of the first workpiece W1 from the state where the probe 36 has reached the second workpiece W2, thereby line-welding a portion of the first workpiece inside the outer edge E of the first workpiece W1 to the second workpiece W2. Thereby, a main welded portion Mj is provided along the outer edge E of the first workpiece W1.

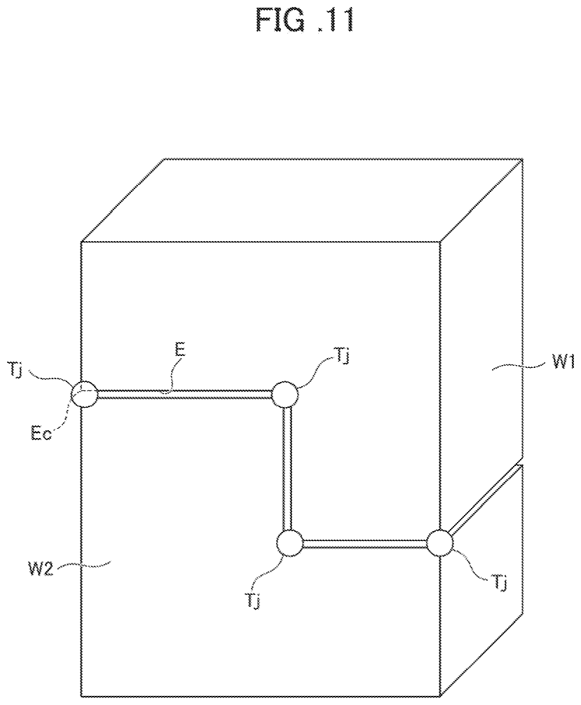

FIG. 11 is a plan view showing workpieces W1 and W2 according to a modification of the present embodiment. As can be seen, the first workpiece W1 may be butted against the second workpiece W2 in a horizontal direction side. Thereafter, a temporarily welded portion Tj may be provided in a portion including a corner Ec; of an outer edge E of the first workpiece W1 and a portion of the second workpiece W2 that faces the corner Ec, and main welding may be performed along the outer edge E of the first workpiece W1.

The effects of the present embodiment summarized as follows. According to the present embodiment, while pressing the workpieces W1 and W2 downward by means of the plurality of spring pins 10 that are spaced apart from one another, the workpieces W1 and W2 are temporarily welded (spot-welded) to each other at a plurality of locations (insertion holes 16) different from the positions of the spring pins 10. Therefore, a certain region that cannot be temporarily welded is smaller, in comparison with a case of temporarily welding the workpieces W1 and W2 to each other outside a surface-pressing part to avoid interference with the surface-pressing part, while pressing the workpieces W1 and W2 downward by means of the surface-pressing part that spreads in a planar shape in the horizontal direction. This feature makes it easy to temporarily weld respective portions of the workpieces W1 and W2 with a sufficient density. Furthermore, in comparison with a case where temporary welding can be performed only outside the surface-pressing part that spreads in the planar shape, the workpieces W1 and W2 can be more easily temporarily welded at an appropriate position where the workpieces are sufficiently in close contact with each other. In the manner described above, firm temporary welding can be efficiently achieved, and even by way of the temporarily welded portion Tj at a spot-welding level, the first workpiece W1 can be inhibited from being turned up due to friction stirring using the main welding step S3. As a result, the workpieces W1 and W2 can be friction stir welded to each other efficiently firmly.

Additionally, the fixing step S1 includes pressing the first workpiece W1 (expanded material) against the second workpiece W2 (die-cast material; by means of the plurality of spring pins 10. Therefore, the second workpiece W2 in which flatness is hard to obtain can be surface-pressed by the first workpiece W1 in which flatness is easy to obtain. Therefore, also in this respect, firm temporary welding can be efficiently achieved.

Furthermore, in the temporary welding step S2, the temporary welding (spot-welding) is performed at the corner Ec that is likely to be turned up in a case of performing the friction stir welding (line-welding) along the outer edge E of the first workpiece W1. Therefore, also in this respect, the first workpiece W1 can be efficiently inhibited from being turned up. Additionally, the corner Ec is hard to press by means of the spring pin 10 and is not very suitable for placing the spring pin 10, and hence the corner portion can be effectively used in performing the temporary welding.

Further, according to the present embodiment, prior to the main welding step S3, the workpieces W1 and W2 only need to be pressed against, the receiving table 19 by means of the plurality of spring pins 10 and temporarily welded (spot-welded), and hence labor and man-hours required prior to the main welding step S3 are reduced, for example, in comparison with a case of flattening the workpieces W1 and W2 by machining. Furthermore, in the subsequent main welding step S3, the temporarily welded portion Tj inhibits the first workpiece W1 from being turned up, and hence a need to decelerate a moving speed of the main welding tool 30 can be reduced. As a result, also in the main welding step S3, the labor and man-hours can be reduced.

As described above, according to the present embodiment, the workpieces W1 and W2 can be friction stir welded to each other efficiently firmly, while reducing the labor and man-hours.

### Second Embodiment

Next, a second embodiment will be described. As to the present embodiment, components and functions that are different from those of the first embodiment will be mainly described on the basis of the first embodiment, and a description of the same or similar components and functions to those of the first embodiment will be omitted as appropriate.

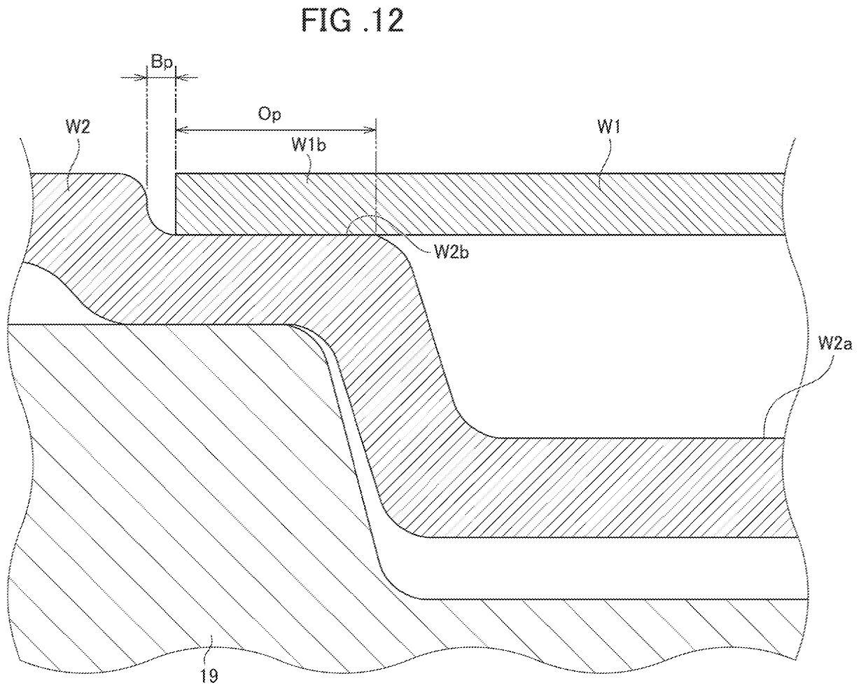

FIG. 12 is a front cross-sectional view showing a fixing step S1. A second workpiece W2 has an opening W2a and a stepped portion W2b. The opening W2a is a portion that opens upward. Specifically, the opening W2a corresponds to a concave portion that opens upward in FIG. 12. However, the opening W2a may be a through hole or the like penetrating the second workpiece W2 in the vertical direction. The stepped portion W2b is recessed downward outside an inner peripheral surface of the opening W2a in the second workpiece W2 and has a bottom surface continuous with the inner peripheral surface of the opening W2a.

In the fixing step S1, a worker or the like places the second workpiece W2 on a receiving table 19 and places a first workpiece W1 on the second workpiece W2. At this time, an outer edge portion W1b of the first workpiece W1 is fitted in the stepped portion W2b of the second workpiece W2.

Hereinafter, a portion including a side surface of the outer edge portion W1b of the first workpiece W1 and a portion of the second workpiece W2 that, faces the side surface is referred to as “a butted portion Bp”. Also, a portion in which the first workpiece W1 and the bottom surface of the stepped portion W2b overlap with each other in the vertical direction is referred to as “an overlap portion Op”.

The worker or the like places the first workpiece W1 on the second workpiece W2 and then mounts a plate 15 (not shown in FIG. 12) on a support stand 17. Thereby, the first workpiece W1 and the second workpiece W2 are fixed to the receiving table 19 while being pressed against the receiving table 19 by means of a plurality of spring pins 10 distributed and arranged in the plate 15.

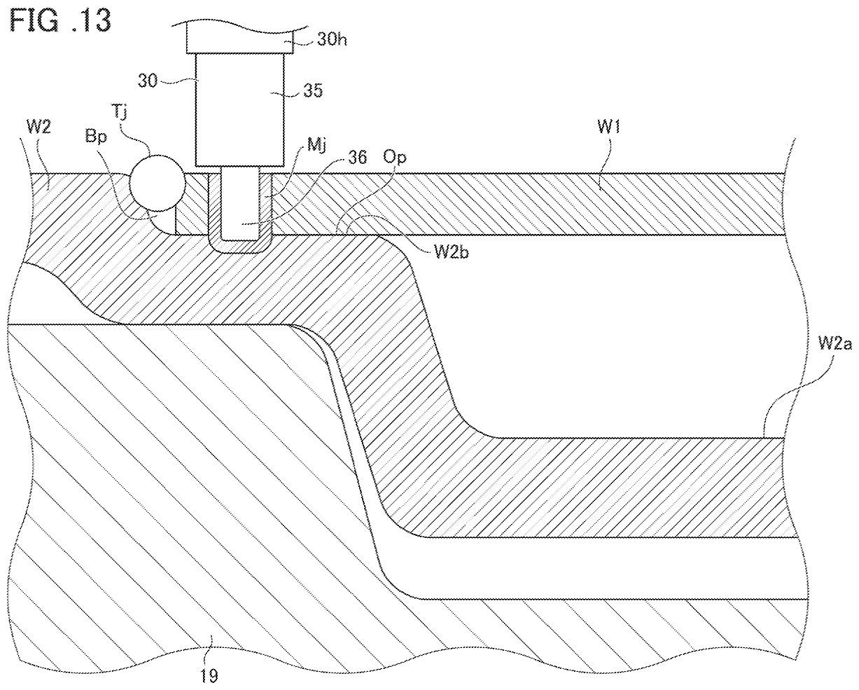

FIG. 13 is a front cross-sectional view showing a main welding step S3. Insertion holes 16 (not shown in FIG. 13) are provided in the plate 15 at a plurality of locations directly above the butted portion Bp. In a temporary welding step S2, a friction stir welding apparatus 50, with a temporary welding tool 20 (not shown in FIG. 13) inserted into an insertion hole 16, spot-welds the first workpiece W1 to the second workpiece W2 in the butted portion Bp, to provide a temporarily welded portion Tj.

In the main welding step S3, the worker or the like removes the plate 15 from the support stand 17. Thereafter, the friction stir welding apparatus 50 moves a main welding tool 30 to a position directly above a desired location in the overlap portion Op, and then, lowers the main welding tool 30 therefrom. Thereby, a probe 36 is pressed onto an upper surface of the first workpiece W1 and is made to penetrate the first workpiece W1 to reach the second workpiece W2. From this state, the friction stir welding apparatus 50 moves the main welding tool 30 along the outer edge portion W1b of the first workpiece W1, to line-weld the outer edge portion W1b of the first workpiece W1 to a bottom portion of the stepped portion W2b of the second workpiece W2. Thereby, a main welded portion Mj is provided along the outer edge portion W1b of the first, workpiece W1.

According to the present embodiment, by fitting the outer edge portion W1b of the first workpiece W1 into stepped portion W2b of the second workpiece, the first workpiece W1 can be positioned to the second workpiece W2, and also in this respect, the temporary welding can be more efficiently performed. Also, in the main welding step S3, the line-welding is performed in the overlap portion Op, and hence a welding strength can be more easily obtained in comparison with a case of performing the line-welding in the butted portion Bp.

### Another Embodiment

The above embodiments may be, for example, modified and implemented as follows. While in the first embodiment, the corner Ec of the outer edge E of the first workpiece W1 is temporarily welded to the second workpiece W2, additionally or alternatively, a portion other than the corner Ec in the first workpiece may be temporarily welded to the second workpiece W2.

### EXPLANATION OF REFERENCE NUMERALS

10: Spring pin

15: Plate

16: Insertion hole

19: Receiving table

20: Temporary welding tool

30: Main welding tool

50: Friction stir welding apparatus

Bp: Butted portion

E: Outer edge of a first workpiece

Ec: Corner of the outer edge of the first workpiece

Op: Overlap portion

S2: Fixing step

S2: Temporary welding step

S3: Main welding step

W1: First workpiece

W2b: Outer edge portion of the first workpiece

W2: Second workpiece

W2a: Opening of the second workpiece

W2b: Stepped portion of the second workpiece

What is claimed is:

1. A friction stir welding method for friction stir welding workpieces to each other, the method comprising:
a fixing step of fixing the workpieces to a receiving table by pressing the workpieces against the receiving table by means of a plurality of spring pins that are spaced apart from one another;
a temporary welding step of spot-welding the workpieces to each other by friction stir welding the workpieces at locations different from positions of the spring pins in a state where the workpieces are fixed; and
a main welding step of line-welding the spot-welded workpieces to each other by friction stir welding.

2. The friction stir welding method according to claim 1, wherein
the temporary welding step includes performing the spot-welding at a corner of an outer edge of a first workpiece as one of the workpieces, and
the main welding step includes performing the line-welding along the outer edge.

3. The friction stir welding method according to claim 1, wherein
the workpieces include a first workpiece made of an expanded material and a second workpiece made of a die-cast material, and
the fixing step includes pressing the first workpiece against the second workpiece by means of the plurality of spring pins.

4. The friction stir welding method according to claim 1, wherein
the workpieces include a first workpiece and a second workpiece,
the second workpiece has an opening that opens in a predetermined direction, and a stepped portion that is recessed in a direction opposite to the predetermined direction and is provided outside an inner peripheral surface of the opening, the stepped portion having a bottom surface continuous with the inner peripheral surface of the opening,
the fixing step includes fitting an outer edge portion of the first workpiece into the stepped portion of the second workpiece, and pressing the first workpiece against the second workpiece in the direction opposite to the predetermined direction by means of the plurality of spring pins,
the temporary welding step includes spot-welding the first workpiece and the second workpiece in a butted portion including a side surface of the outer edge portion of the first workpiece and a portion of the second workpiece that faces the side surface, and
the main welding step includes line-welding the first workpiece to the second workpiece in an overlap portion in which the bottom surface of the stepped portion and the first, workpiece overlap with each other in the predetermined direction.

5. A friction stir welding apparatus for friction stir welding workpieces to each other, the apparatus comprising:
a plate including spring pins mounted at a plurality of locations that are spaced apart from one another, and having insertion holes in a plurality of locations that are different from and do not interfere with the plurality of locations, the plate being configured to fix the workpieces to a receiving table by pressing the workpieces against the receiving table by means of the plurality of spring pins;
a temporary welding tool that spot-welds the workpieces to each other by friction stir welding in the insertion holes; and
a main welding tool that line-welds the spot-welded workpieces to each other by friction stir welding.
